(19) United States
(12) Patent Application Publication
(10) Pub. No.: US 2018/0054706 A1
(43) Pub. Date: Feb. 22, 2018

(54) SYSTEM FOR AUTO-COMMISSIONING OF LUMINAIRES AND ASSET TRACKING

(71) Applicant: ABL IP HOLDING LLC, Conyers, GA (US)

(72) Inventors: Jenish S. Kastee, South Riding, VA (US); Sean P. White, Reston, VA (US); Daniel M. Megginson, Fairfax, VA (US); Januk Aggarwal, Tysons Corner, VA (US); David P. Ramer, Reston, VA (US)

(21) Appl. No.: 15/241,350

(22) Filed: Aug. 19, 2016

(51) Int. Cl. H04W 4/02; H05B 37/02; H04W 24/10; H04W 40/24; H04L 12/727; G01S 5/02; G01S 5/00

(52) U.S. Cl. CPC H04W 4/023; H05B 37/0272; H04W 24/10; H04W 40/244; G01S 5/0063; G01S 5/0289; G01S 5/0294; G01S 5/0072; H04L 45/121

(57) ABSTRACT

A system includes luminaires at a premises, where each luminaire has a light source, processor and radio frequency (RF) transceiver. The processor is configured to control the RF transceiver of the respective luminaire to transmit ranging signals to neighboring luminaires and receive response signals from neighboring luminaires. The processor computes time of flight (ToF) values relative to the neighboring luminaires. The system also includes a location solving server having a processor configured to receive the ToF values from the luminaires, compute relative distances between the luminaires based on the ToF values, and determine relative locations of the luminaires within the premises based on the computed relative distances between luminaires. Knowledge of the relative locations of the luminaires, for example, may be used in personnel or asset tracking, e.g. based on data sent via light from the luminaires or by ranging and response signals exchanged with RF enabled assets.

### TECHNICAL FIELD

The disclosed subject matter relates to improvements in auto-commissioning of radio frequency (RF) enabled luminaires and/or asset tracking of RF enabled assets using such luminaires.

### BACKGROUND

Traditional lighting devices have tended to be relatively dumb, in that they can be turned ON and OFF, and in some cases may be dimmed, usually in response to user activation of a relatively simple input device. Lighting devices have also been controlled in response to ambient light detectors that turn on a light only when ambient light is at or below a threshold (e.g. as the sun goes down) and in response to occupancy sensors (e.g. to turn on light when a room is occupied and to turn the light off when the room is no longer occupied for some period). Often traditional lighting devices are controlled individually or as relatively small groups at separate locations.

With the advent of modern electronics has come advancements, including advances in the types of light sources as well as advancements in networking and control capabilities of the lighting devices. For example, solid state sources are now becoming a commercially viable alternative to traditional light sources such as incandescent and fluorescent lamps. By nature, solid state light sources such as light emitting diodes (LEDs) are easily controlled by electronic logic circuits or processors. Electronic controls have also been developed for other types of light sources. As increased processing capacity finds its way into the lighting devices, it becomes relatively easy to incorporate associated communications capabilities, e.g. to allow lighting devices to communicate with system control elements and/or with each other. In this way, advanced electronics in the lighting devices as well as the associated control elements have facilitated more sophisticated lighting control algorithms as well as increased networking of lighting devices.

Visible light communication (VLC) is one application of controllable lighting devices. VLC transmits information in indoor or outdoor locations, for example, from an artificial light source to a mobile device. The example VLC transmission may carry broadband user data, if the mobile device has an optical sensor or detector capable of receiving the high speed modulated light carrying the broadband data. In other examples, the light is modulated at a rate and in a manner detectable by a typical imaging device (e.g. a rolling shutter camera). This later type of VLC communication, for example, supports an estimation of position of the mobile device and/or provides some information about the location of the mobile device. These VLC communication technologies have involved modulation of artificially generated light, for example, by controlling the power applied to the artificial light source(s) within a lighting device to modulate the output of the artificial light source(s) and thus the light output from the device.

Deployment of substantial numbers of lighting devices with associated controllers and/or sensors and networking thereof presents increasing challenges for set-up and management of the system elements and network communication elements of the lighting system. In at least some applications, system commissioning may involve accurate determination of locations of installed lighting devices such as luminaires.

For a VLC location service, for example, it is desirable for the system to know the location of the luminaires, so that each luminaire can provide its location in the VLC signal or so that a mobile device or the like can look up an accurate luminaire location. The location of the mobile device can then be determined based on luminaire location data obtained by the mobile device. The location of each luminaire in a venue is determined as a part of the commissioning operation that is typically performed soon after the luminaire is installed. Depending on the number of luminaires and the size and configuration of the venue, the commissioning operation may be time consuming.

There have been recent proposals to deploy intelligent luminaires for VLC positioning services that also include a wireless communication capability, for example, provided by inclusion of a Bluetooth or other wireless transceiver in each luminaire. Commissioning of such VLC-Bluetooth hybrid light fixtures often has involved a localized communication process between each RF (e.g. Bluetooth) enabled light fixture and an RF enabled user terminal in which each fixture is manually configured to be associated with a relative position with respect to other RF enabled light fixtures in the vicinity. However, this commissioning process is costly, time consuming, and is not guaranteed to be accurate because of the human interaction required for its execution.

Also, building an installed base of such intelligent lighting equipment, with substantial numbers of lighting devices each having sophisticated electronics, incurs a financial investment. In many cases, the electronics are a substantial cost for each luminaire, and that cost may be multiplied by a large number of such devices in an extensive networked implementation owned by or operated for a large enterprise. Hence, in addition or as an alternative to room for improvement in commissioning, there is room for improvement in the usage of the resources in lighting devices, e.g. to develop other services or applications that take advantages of the installed infrastructure.

### BRIEF DESCRIPTION OF THE DRAWINGS

The figures depict one or more implementations in accordance with the present teachings by way of example only, not by way of limitation. In the figures, like reference numbers refer to the same or similar elements.

FIG. 1A shows a system diagram of a luminaire which may implement auto-commissioning and/or asset tracking functions.

FIG. 1B is a simplified functional block diagram of a computer configured as a server, for example, to function as the location solving server in FIG. 1A.

FIG. 2 shows a flow diagram for the auto-commissioning and asset tracking.

FIG. 3 shows the discovery mode for auto-commissioning multiple luminaires.

FIG. 4 shows the asset tracking mode implemented via a number of luminaires.

FIG. 5 shows an example of the luminaires tracking multiple assets.

FIG. 6 shows a flowchart describing the discovery mode for multiple auto-commissioning luminaires.

FIG. 7 shows a relay/beacon example of executing the discovery mode.

FIG. 8 shows a flowchart describing the relay/beacon example of executing the discovery mode.

FIGS. 9A and 9B show a flowchart of both the auto-commissioning process and the asset tracking process.

### DETAILED DESCRIPTION OF EXAMPLES

In the following detailed description, numerous specific details are set forth by way of examples in order to provide a thorough understanding of the relevant teachings. However, it should be apparent that the present teachings may be practiced without such details. In other instances, well-known methods, procedures, and/or components have been described at a relatively high level, without detailed comment in order to avoid unnecessarily obscuring aspects of the present teachings.

Luminaires (e.g. light fixtures, floor or table lamps, or other types of lighting devices for artificial illumination) are widely used in various residential, commercial and industrial settings for providing illumination in both interior and exterior spaces. For example, a retail store may install multiple luminaires in the ceiling for illuminating products and walking area throughout store. The luminaires discussed in the examples may be installed or otherwise located in or about a particular premises. Although the premises may be a single property and associated building structure, the term premises is used in the examples to also encompass installations and/or operations of the luminaires at more than a single site or building, such as a block or a campus. The system, however, can scale further to larger environments, for example, to application at the level of a city, a state, etc.

The term “luminaire” as used herein is intended to encompass essentially any type of device that processes power to generate light, for example, for illumination of a space intended for use of or occupancy or observation, typically by a living organism that can take advantage of or be affected in some desired manner by the light emitted from the device. However, a luminaire may provide light for use by automated equipment, such as sensors/monitors, robots, etc. that may occupy or observe the illuminated space, instead of or in addition light for an organism. A luminaire, for example, may take the form of a table lamp, ceiling light fixture or other lighting device that incorporates a source, where the source by itself contains no intelligence or communication capability (e.g. LEDs or the like, or lamp (“regular light bulbs”) of any suitable type). Alternatively, a lighting device or luminaire may be relatively dumb but include a source device (e.g. a “light bulb”) that incorporates the intelligence and communication capabilities described herein. In most examples, the luminaire(s) illuminate a service area to a level useful for a human in or passing through the space, e.g. regular illumination of a room or corridor in a building or of an outdoor space such as a street, sidewalk, parking lot or performance premises served by a lighting system may have other lighting purposes, such as signage for an entrance or to indicate an exit. Of course, the luminaires may be configured for still other purposes, e.g. to benefit human or non-human organisms or to repel or even impair certain organisms or individuals.

As outlined above, each luminaire includes a light source. The actual source in each luminaire may be any type of light emitting unit. Examples of light sources include light emitting diodes (LEDs), incandescent or fluorescent lamps, halogen or halide lamps, neon tubes, etc.

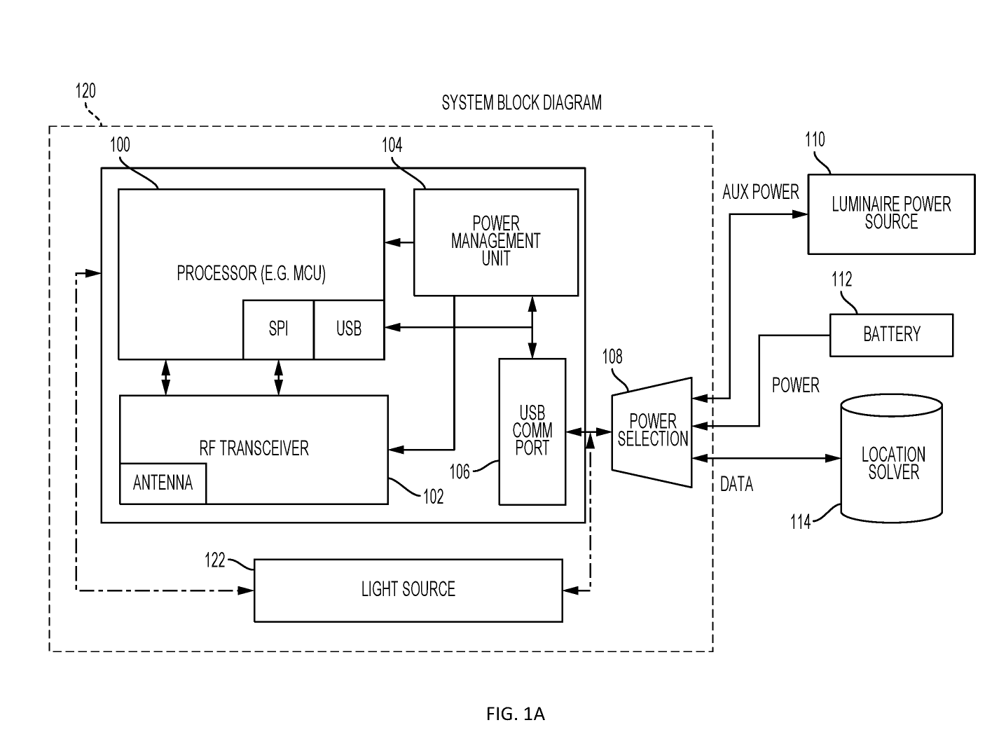

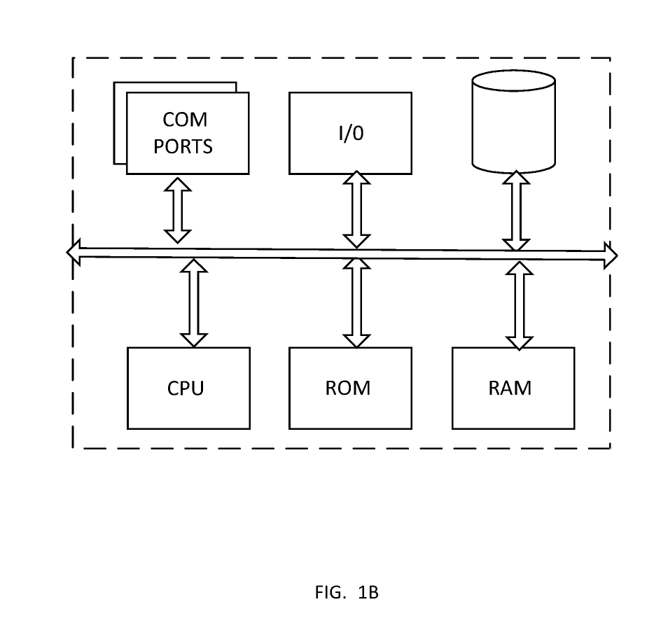

In the examples, the luminaires also have smart capabilities. For example, the luminaires may include a processor as well as radio frequency (RF) transceiver to perform communication with other luminaires and other wireless devices (e.g. SmartPhones, assets to be tracked, etc.). An example of such a luminaire is shown in FIG. 1A where luminaire 120 includes a light source 122, a processor 100, a power management unit 104, a communication port 106 and an RF transceiver 102. Although shown as one combined unit, the elements of the luminaire may be implemented somewhat separately, e.g. with the light source of a luminaire separated from but controlled by an associated processor of the luminaire. Alternatively, one processor may control some number of light sources and RF transceiver(s) at diverse locations about a premises.

In the examples of FIG. 1, the luminaire 120 is shown as having one processor 100, for convenience. In some instances, such a lighting device may have multiple processors. For example, a particular device configuration may utilize a multi-core processor architecture. Also, some of the other components, such as the communications interfaces, may themselves include processors. Alternatively, the processor and associated memory in the luminaire may be components of a Micro-Control Unit (MCU), which is a microchip device that incorporates a processor serving as a programmable central processing unit (CPU) as well as one or more of memories. The MCU may be thought of as a small computer or computer-like device formed on a single chip.

A location solver 114 has a communication link/session for data communication with circuitry and/or programming of the luminaire 120. It should be noted that the electronic components of luminaire 120 may be powered by various electrical sources including power source 110 which may be the internal power source of the luminaire itself or an external power source of another nearby luminaire, an internal battery 112, or the power supply of a separate processing device such as location solver 114 (e.g. server) shown in FIG. 1A. In the example, the power selection unit 108 (e.g. a switch) allows logic implemented by the luminaire 120 to switch between a number of different power sources for powering the luminaire electronics. In either scenario, the electrical power is input through port 106 and then fed to power management unit 104 which distributes the power to both processor 100 and RF transceiver 102. Although the data link from the location solver 114 is shown going through the power selection unit 108, other connection arrangements may be used (e.g. without going through the power selection unit 108 in configurations in which the solver 114 is not a source of power).

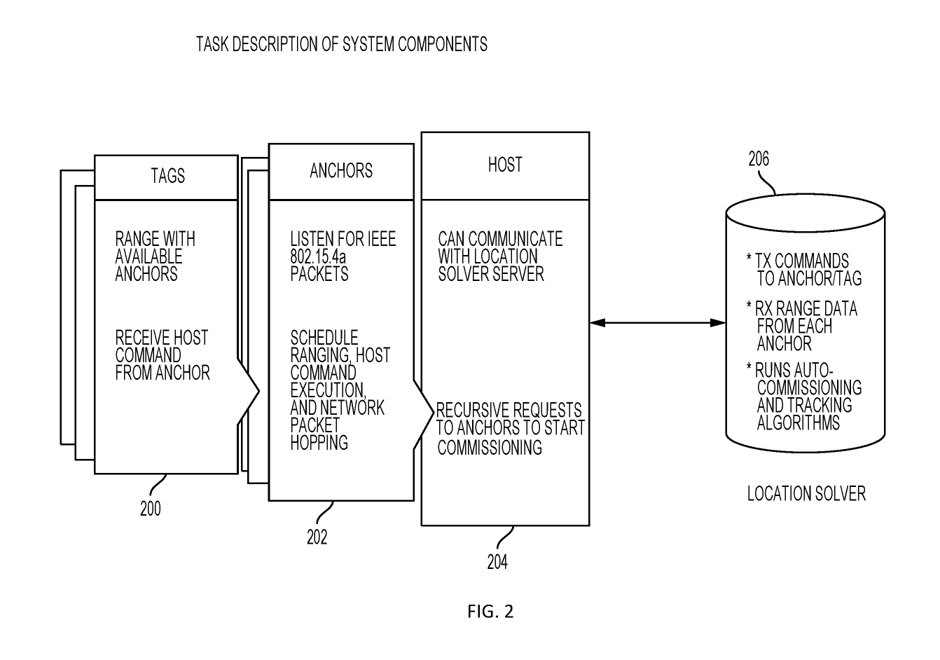

The RF transceiver 102 may be implemented using a variety of wireless radio frequency transceiver technologies. Examples of RF wireless transceivers include Bluetooth transceivers, WiFi transceivers, 900 MHz (sub-GHz) wireless transceivers, ultra-wideband (UWB) transceivers, etc. An example of relevant luminaire related data (e.g. referenced in FIG. 2) uses UWB transceivers and may conform to the IEEE 802.15.4a wireless communication standard.

In general, processor 100 of luminaire 120 controls the other components of the luminaire. For example, processor 100 controls RF transceiver 102 to communicate with other RF devices. In addition, processor 100 controls the light source 122 to turn ON/OFF via power selection unit 108. The processor 100 control other aspects of operation of the light source 122, such as light output intensity level, associated color characteristic(s) of the light output, focus and/or aiming of the light output, etc. Of note for purposes of discussion of several operational examples, the processor controls communications RF-based ranging operations via the transceiver 102 and associated communications relating to location estimations and the like with the location solver 114.

FIG. 1B illustrates an example the location solver 114 implemented as a server that includes a data communication interface for packet data communication (e.g. with one or more of the luminaires and other assets) via the particular type of available network (not separately shown) with other devices. The data communication interface may be wired or wireless. For communication with luminaires, like 120, the communication interface of the server will be similar to or otherwise compatible with the RF wireless communication capabilities of the transceiver 102 of the luminaire(s).

The location solver 114 may be a physical server computer on the network that the system is connected to via wireless or wired medium. It could also be implemented as a server instance running in the cloud. Alternatively, the server for the solver 114 could be a processor on a luminaire (either 100 in FIG. 1A or a separate processor). Perhaps, the location solver 114 could be a form of distributed processing system, e.g. a server program that runs on the processors of some number of luminaires.

For purposes of further discussion, FIG. 1B shows a computer platform as an example of an implementation of the hardware for a location solver configured/programmed as an appropriate server. The server computer includes a CPU for executing program instructions, such as the appropriate server application program(s). The computer server platform typically includes an internal communication bus, program storage and data storage for various data files to be processed and/or communicated by the server, although the server often receives programming and data via network communications. Of course, the server functions may be implemented in a distributed fashion on a number of similar platforms, to distribute the processing load. Also, a computer configured as a server with respect to one layer or function may be configured as a client of a server in a different layer and/or for a different function. It is believed that those skilled in the art are adequately familiar with the structure, programming and general operation of computer equipment, such as that shown in FIG. 1B, and as a result, the drawing should be self-explanatory.

Deployment of substantial numbers of the luminaires 120 with associated processors 100 and wireless networking transceivers 102 involves provisioning those devices 120 for communication and configuration or commissioning of the devices 120 for appropriate operation at the premises. For some applications, system commissioning may involve accurate determination of locations of installed lighting devices such as luminaires. As noted, one example in which location determination as part of the commissioning process may be significant relates a VLC location service. In that example, it is desirable for the luminaires or another element in or in communication with the lighting system to know the location of the luminaires. Each luminaire then can provide either its location or a code correlated to its location in the VLC signal the luminaire emits. A mobile device or the like can receive or look up an accurate luminaire location, which it uses to obtain an estimate of its own location or position. The location of the mobile device can then be determined based on luminaire location data obtained by the mobile device. The location of each luminaire in a venue is determined as a part of the commissioning operation that is typically performed soon after the luminaire is installed. Examples of position determination during commissioning, using the RF communication capabilities of the luminaires are described in more detail below.

UWB technology IEEE 802.15.4a allows for simultaneous data communication and ranging. Transceivers of a type compatible with that standard may also offer relatively low power consumption as the transceiver does not need to be turned on just for data communication. When on for any reason, such a transceiver may be used for ranging and associated commissioning and/or for asset tracking or the like. Alternatively, the transceiver may only be turned on to perform both functions simultaneously, in which case power is conserved by leaving the transceiver in the off state for longer periods.

Since luminaire 120 is equipped with an RF transceiver 102, the luminaire 120 also is able to communicate with other luminaires and possibly with various other wireless devices in or about the premises. These other wireless devices may actually be assets within the store or the like, assuming that the assets have compatible wireless communication capabilities. Examples of these assets include but are not limited to products in the store, patron mobile phones, employee mobile phones, and generally anything that is equipped to transmit and receive RF signals using frequencies and protocols compatible with those used by the luminaires in the store in our example. Using this RF capability, luminaire 120, along with other luminaires within a store are able to determine and track the location of these assets over time. This may be beneficial for the store to track the products within the store, customers within the store and employees within the store. Although the store is discussed as the example, the wireless tracking service may apply to tracking personnel and other assets in other types of premises or enterprise facilities. Like VLC based positioning, accurate tracking utilizes accurate position or location information about the luminaires at the premises, obtained during the luminaire commissioning process.

Before being able to track assets in the premises, luminaire 120, as well as the other luminaires that are installed within the store or the like are commissioned. Commissioning, for example, entails initializing the various electronics within a luminaire such that the electronics are initialized and bought into working condition (i.e. communicating with each other). Any data needed to provision the luminaire for network communication and/or needed to configure the device for luminaire operation. In addition, the locations of each of the luminaires 120 relative to one another are determined in the commissioning procedure examples discussed more fully below.

The example of an additional application above relates to asset tracking using luminaires. The system, however, may also support other applications utilizing the embedded RF wireless communication capabilities. For example, a variety of building management assets may be commissioned, including location determinations, as elements of the system. Such managed equipment may include components of a heating, ventilation and air-conditioning (HVAC) system, access control elements (e.g. at doors and window, etc.), closed circuit surveillance cameras, or the like. Once commissioned/located, such building management assets can be monitored and possibly tracked, e.g. if relocated or could be used as additional anchors.

As shown in FIG. 2, each of the luminaires will be labeled in a record in an appropriate data system (e.g. in a database on the location solver) either as a tag 200, an anchor 202 or a host 204. These labels are given based on the relative mode of operation of the luminaires during the commissioning process and/or subsequent position ranging operations for estimating position and possibly attendant tracking services. For example, a luminaire that recursively sends requests to other luminaires during commissioning phase to start commissioning process and that luminaire itself does not respond to a polling/ranging requests is labelled as a “host.” The location solver 206 (i.e., a server) would be the “host” to the luminaire that is communicating directly with the location solver 206. During asset tracking phase, a host does not send requests to start commissioning, but a host sends relevant commands to anchors and/or tags. Hence, a host is or can communicate with the location solver. A luminaire acting as a host may communicate with the location solver via USB (e.g. if local) or via other local or network communication media. As explained in more detail later, a host recursively requests anchor(s) to start the commissioning process.

The luminaires or other RF enabled assets within the premises that initiate polling/ranging and do not have position information relating to neighbor luminaires are labelled as tags 200. These tags 200 receive commands from both the host 204 and anchors 202. Neighboring luminaires that respond to polling/ranging requests are labeled as anchors 202. The anchors communicate with tags and may communicate with each other. For example, such anchors may schedule ranging operations, execute commands from the host and/or provide mesh packet hopping for other communications.

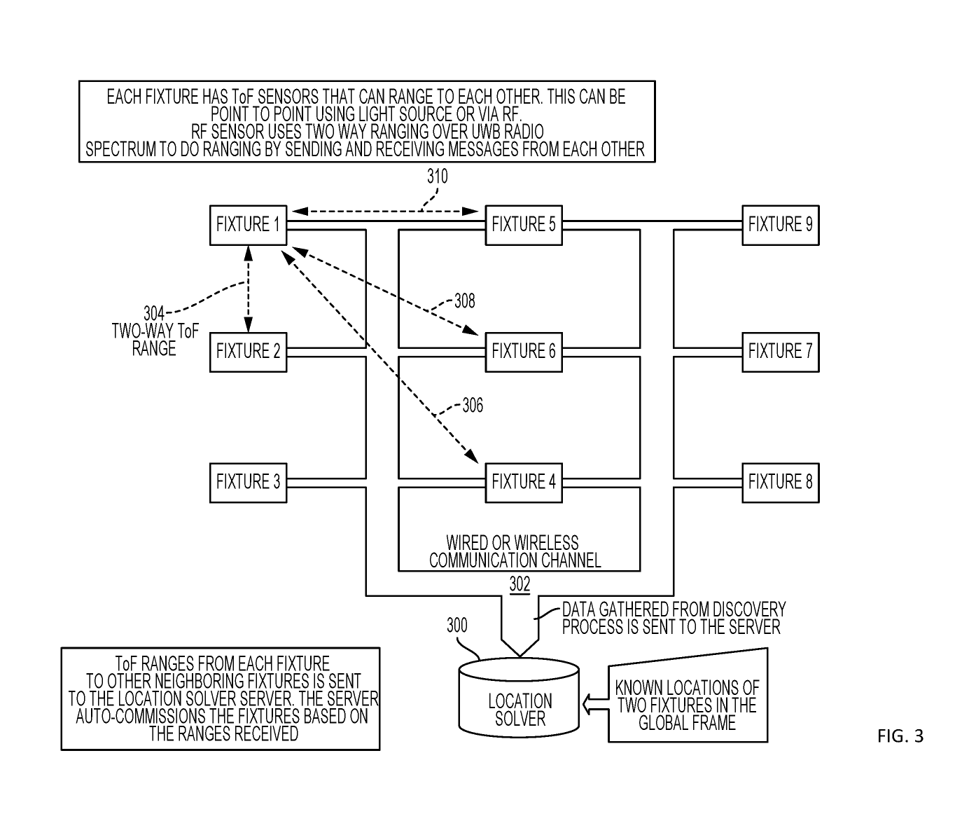

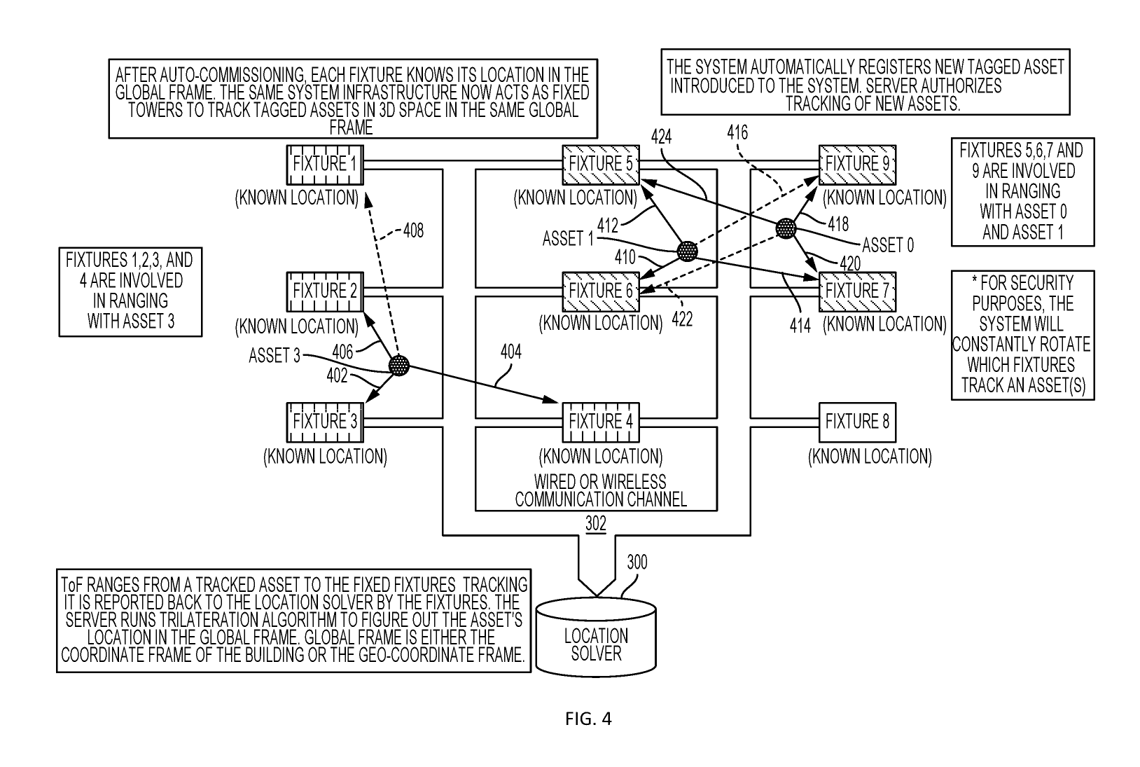

An example of the overall commissioning process will now be described with respect to FIGS. 3 and 4.

Shown in FIG. 3 is an overall layout of luminaires (e.g., commercial light fixtures 1-8) which are located in a particular setting (e.g., a retail store). Each of the fixtures 1-8 in the example includes the various components shown in luminaire block 120 of FIG. 1A. Thus, each of these fixtures has RF capabilities to communicate with other neighboring fixtures and assets.

Essentially, the commissioning process is an automatic iterative process where each of the fixtures transmits/receives ranging/response signals in order to determine time of flight (ToF) between itself and other neighboring fixtures; a tree search method is used to discover fixtures over multiple iterations. For example, ToF may be determined by fixture 1 transmitting ranging signals 304, 306, 308 and 310 to neighboring fixtures 2, 4, 5 and 6. Fixture 1 determines the time it takes between transmitting the ranging signal and receiving response signals from fixtures 2, 4, 5 and 6. This overall time round trip time, minus the actual processing time of the signal by each receiving fixture, is the ToF which may then be sent to location solver 300 in our example.

Alternatively, each transmission could include a timestamp. A receiving signal could determine time of flight from a transmitter, store the data for its own use (if desired) and/or send back the measured time value in another message with a new time stamp. The first station, fixture 1 in our example, would receive the measured flight time of its transmission to a receiving station and could separately calculate the time of flight of the response based on a timestamp in the response and a clock at fixture 1. Either time of flight value or the round trip time of flight (sum) could be used in further processing. Returning to a specific example, for purposes of further discussion of the example of FIG. 3, we will assume fixture 1 determines a round trip time of flight ToF based on time from transmission from fixture to time of receipt of a response (possibly minus projected processing time by the respective responding fixture).

In general, each of the light fixtures performs this process to obtain ToF data for its neighbors and sends the ToF data back to location solver 300. Once the ToF data is received, location solver 300 then computes the relative distances between the various fixtures. This may be accomplished by trilateration computations. Once the relative locations of each of the fixtures are determined, location solver 300 is able to generate a map of the locations of the fixtures within the premises.

An example of an auto-commissioning process, generally is as follows. All fixtures start out as anchors. Assuming fixture 4 in FIG. 3 directly communicates with location solver 300 (physical external server in this example) and is selected by the location solver as the starting point, fixture 4 would become a tag and transmit ranging signals and receive response signals from its neighboring fixtures (e.g., fixtures 3, 6 and 8). Thus, fixture 4 would compute ToF data to each of these three fixtures.

Next, fixture 4 would switch to host mode and pick one of fixtures 3, 6 and 8 to perform the next round in the commissioning process. The selection may be random or otherwise systematic. For example, if fixture 4 randomly picked fixture 8, then fixture 8 would become a tag and would transmit ranging signals and receive response signals from its neighboring fixtures in order to determine ToF data to its neighboring fixtures; fixture 4 is the host to fixture 8. Alternatively, fixture 4 may respond with a “no ranging” signal to indicate that it is no longer a tag. In either of these example, the non-response or the response that a fixture is no longer an anchor helps to avoid redundant information being collected and reduces the amount of wireless transmissions involved in the commissioning process.

Continuing with the example, if fixture 8 is the new tag selected by fixture 4, then fixture 8 would transmit a ranging signal to fixtures 4, 6 and 7. Fixtures 6 and 7 would respond to the ranging signals, but fixture 4 would not respond since fixture 4 is a host now. Thus, fixture 8 would compute the ToF values to fixtures 6 and 7. Fixture 8 would then become a host and would select (e.g. at random) either fixture 6 or fixture 7 to perform the next round in the commissioning process. Once the discovery of fixtures and associated data collection reaches the end of a branch (e.g. in a depth search method), the last host will then request the next branch to be followed until there are no more unvisited branches. This process would essentially be repeated throughout the entire matrix of fixtures until all of the ToF values are collected. One benefit to performing this type of process is that all of the ToF values are collected, while redundant computations are avoided. Once all the ToF values are computed, fixture 4 (i.e., the primary host) collates all of these values from the other fixtures and transmits these values to location solver 300. As another example, some or all of the fixtures could have a direct connection back to the location solver (e.g. via Ethernet). Then, each host with such a connection would send all of its known ToF data straight to the location solver instead of passing it up the chain to its host.

Once location solver 300 has received all the ToF values from fixtures 1-8, location solver 300 is then able to determine relative distances between the fixtures and create a map showing the relative distances between the fixtures within the store. In addition to the location map, the location solver 300 can also determine the best data communication path between the fixtures in the store using path finding algorithms such as A* or Dijkstra's shortest path algorithm to compute a shortest communication path to each of the luminaires from the location solving server. This essentially minimizes the amount of hops required for performing communication through the fixture matrix. It should be noted that determining the relative locations between the fixtures and the overall map may be performed using trilateration techniques.

Once location solver 300 has determined the location map of fixtures 1-8, this map may be utilized for location estimations, e.g. for VLC-based position determination and related location based services, and/or to track RF capable assets within the store or other premises. It may be helpful to consider an example of tracking RF capable assets. In FIG. 4, the map of fixtures 1-8 is shown relative to the positions of assets 0, 1 and 3. After the auto-commissioning process, the tracking process of assets 0, 1 and 3 may commence.

Essentially, the RF-based asset tracking process is somewhat similar to the auto-commissioning in that assets 0, 1 and 3 also receive ranging RF signals and transmit responsive RF signals in order for the system to determine ToF values. In the asset tracking examples, the ToF values are for the exchange of signals from the light fixtures to the assets and back to the light fixtures. Generally, the ToF values may be determined between each of the assets and the neighboring fixtures (i.e., the fixtures that are closest to a particular asset).

For example, fixtures 5, 6, 7 and 9 may transmit ranging signals to asset 0 which responds by transmitting response signals 418, 420, 422 and 424 to fixtures 5, 6, 7 and 9. Similarly, asset 1 may transmit response signals 410, 412, 414 and 416 to fixtures 5, 6, 7 and 9. Likewise, asset 3 may transmit response signals 402, 404, 406 and 408 which are received by fixtures 1, 2, 3 and 4. The ToF values computed by fixture are then relayed back to location solver 300.

Since the relative locations between the fixtures are already known due to the auto-commissioning process, location server 300 can utilize trilateration techniques in order to determine the relative distance between the fixtures (at their known locations) to the assets at the unknown locations. This allows location solver 300 to map the assets relative to the known locations of the fixtures 1-8 which allows the assets to be affirmatively located. Periodically repeating steps to obtain ToF values for the signals to/from the assets, compute distances and map asset locations enables the system to track the assets location and movement throughout the premises.

It should be noted that although the light fixtures transmitted the ranging signals and the assets transmitted the response signals in the example above, the opposite could be true. As long as ToF values for RF exchanges between the fixtures and the assets are determined and reported to the server, the assets can be located and tracked.

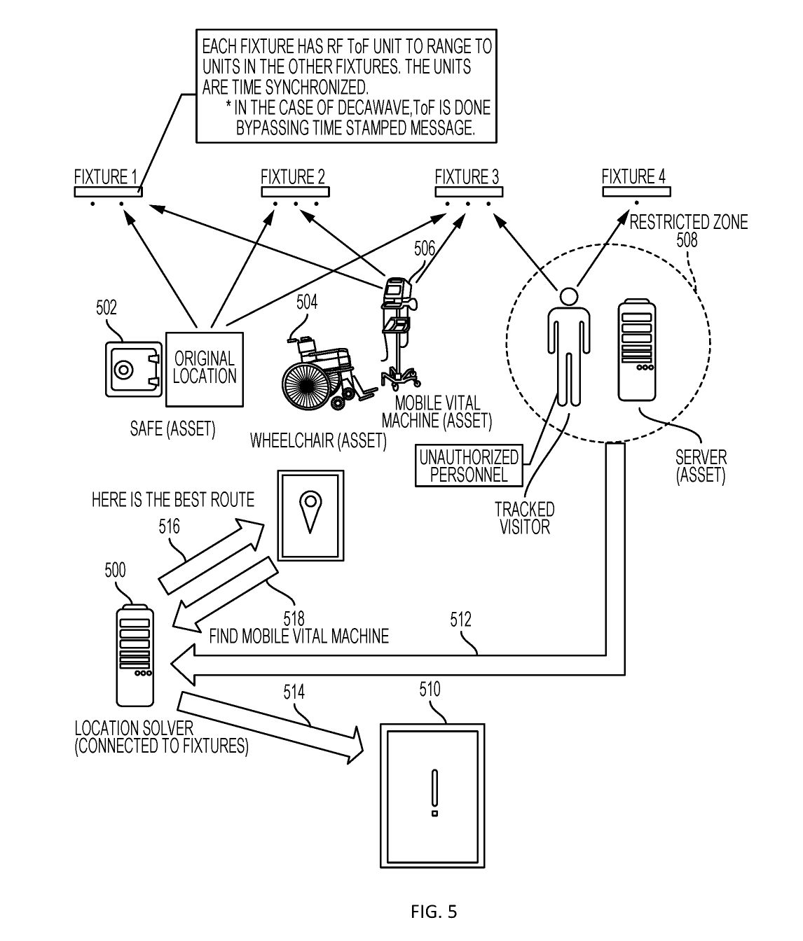

A real world example of fixtures mounted to the ceiling of a retail store or the like and locating and tracking assets is shown in FIG. 5. Specifically, fixtures 1-4 are mounted to the ceiling of the store. Assets such as safe 502, wheelchair 504, medical device 506 and mobile device 508 are located throughout the store. Each of these assets (although not shown) include RF transceivers that are able to communicate wirelessly with fixtures 1-4, e.g. so that those assets are able to exchange ranging/response signals ToF measurements as discussed in earlier examples.

In this example, mobile phone 508 of a tracked visitor is in direct communication with location solver server 500. This means that the mobile device 508 is essentially the tag which collects all of the ToF values from all of the assets within the store and relays this information to location solver 500 via data communication shown at line 512. In practice, assets 502, 504, 506 and 508 may transmit ranging signals to the fixtures and receive the responses or the fixtures may transmit ranging signals to the assets 502, 504, 506 and 508 and receive the responses. The response are used to calculate ToF values between the assets and fixtures. These ToF values are then relayed to location solver 500, in this example, via the mobile phone 508. This essentially allows location solver 500 to determine the locations of the assets relative to the locations of the fixtures.

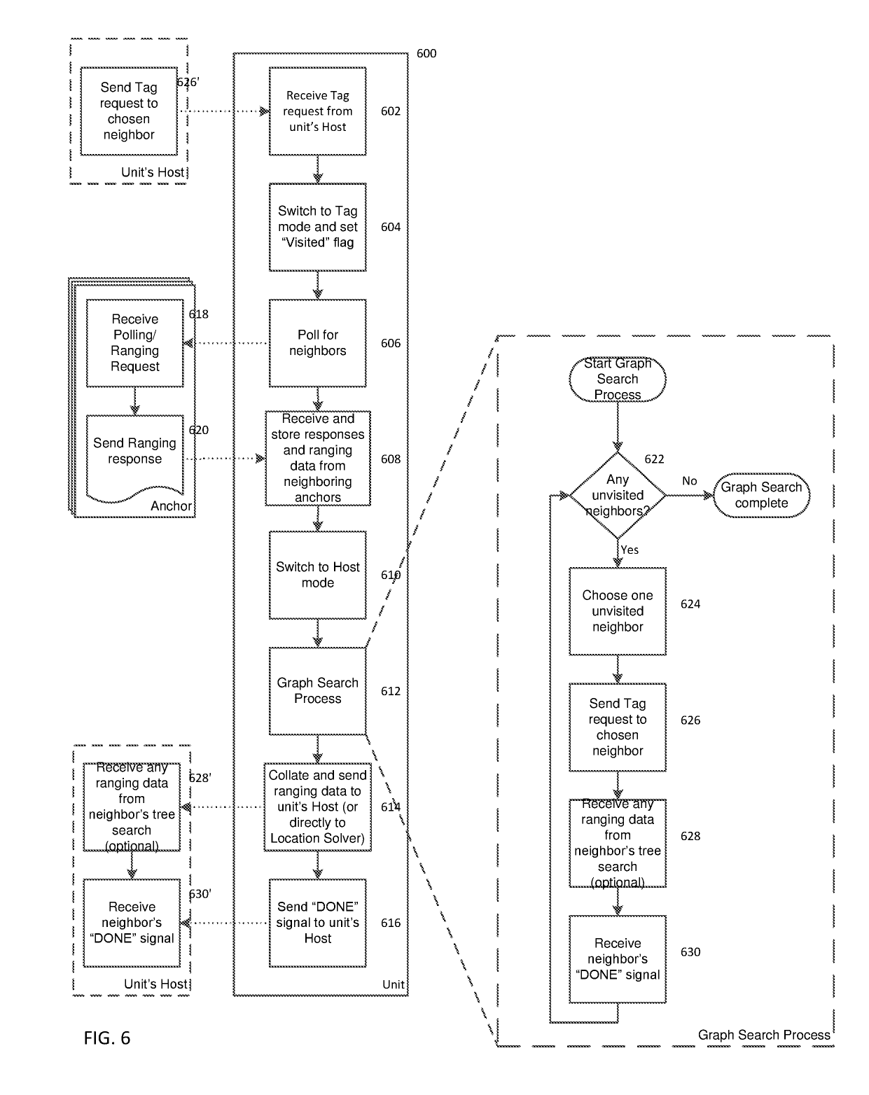

The flow chart in FIG. 6 shows the recursive communications amongst anchors as another illustration of commissioning of the type disclosed herein. During the commissioning process depicted in this example, each fixture goes through three modes, an anchor (i.e. a device that responds to polling/ranging requests), a tag (i.e. a device that initiates polling/ranging requests), and a host (i.e. a device that requests an anchor to recursively start the commissioning process and does not respond to polling/ranging requests). To simplify the description, the term “Unit” is used to describe one fixture as it goes through the commissioning process.

In step 602, the unit 600 receives a Tag request from a host (or location solver) 626′. This causes unit 600 to initiate the commissioning process. In step 604, the unit switches from Anchor mode to Tag mode so it can poll for neighbors and initiate ranging requests. It also sets a “Visited” flag that remains until the entire network has been mapped and an end of commissioning signal is sent to the entire network by some suitable mechanism. The unit 600 sends out a polling/ranging request 606 to determine if there are any nearby Anchors (i.e. fixtures that do not have their “Visited” flag set). The nearby anchors receive the request 618 and then send their ranging response 620 back. In step 608, the unit receives all the responses (if any) and stores the anchor IDs and associated ranging information for each neighbor anchor.

The unit then switches to Host mode 610 and initiates a suitable graph search process 612. In this example, the unit determines if there are any unvisited neighboring anchors in step 622. If there are, the process continues to step 624 where one of the neighboring anchors is chosen by any suitable means (e.g. randomly or systematically). A tag request 626 is sent to that neighbor anchor in the same way that the unit's host had sent it Tag request 626′. The unit waits for the neighboring anchor to complete its commissioning process. When the neighboring anchor has completed its part of the tree mapping, it may send back a collated set of ranging data which the unit stores while all other branches under the unit are traversed. If the neighboring anchor has an independent data connection the location solver, it may send its ranging data directly to the location solver and only send back a “DONE” signal. The unit receives this “DONE” signal, as shown in box 630, and then goes back to step 622 and checks if there are any more unvisited neighbor anchors. The graph search process is iterative or recursive in that the unit repeats the graph search neighbor by neighbor until there are no more unvisited neighbor anchors, at which point the unit moves on to step 614.

The unit collates the ranging data it obtained in step 608 with any data returned by neighbors during the graph search process in step 612. If the unit has a direct data connection to the location solver, it may send this collated ranging data directly to the location solver, otherwise it sends it back to its host. The unit then sends its host the “DONE” signal and is then done until the end of commissioning signal is received.

In this example, a Depth First graph search method is described. Someone skilled in the art would recognize that any suitable graph traversal method could be used. Examples of other suitable graph traversal methods include Breadth First, Monte Carlo, Best First, etc. Also in this example, a single host initiates the commissioning process. However, another implementation of commissioning could involve multiple hosts being initiated simultaneously to collectively discover all luminaires quickly. Such an implementation would have a mechanism to detect collisions with other hosts and would adaptively explore only the areas that are non-intersecting.

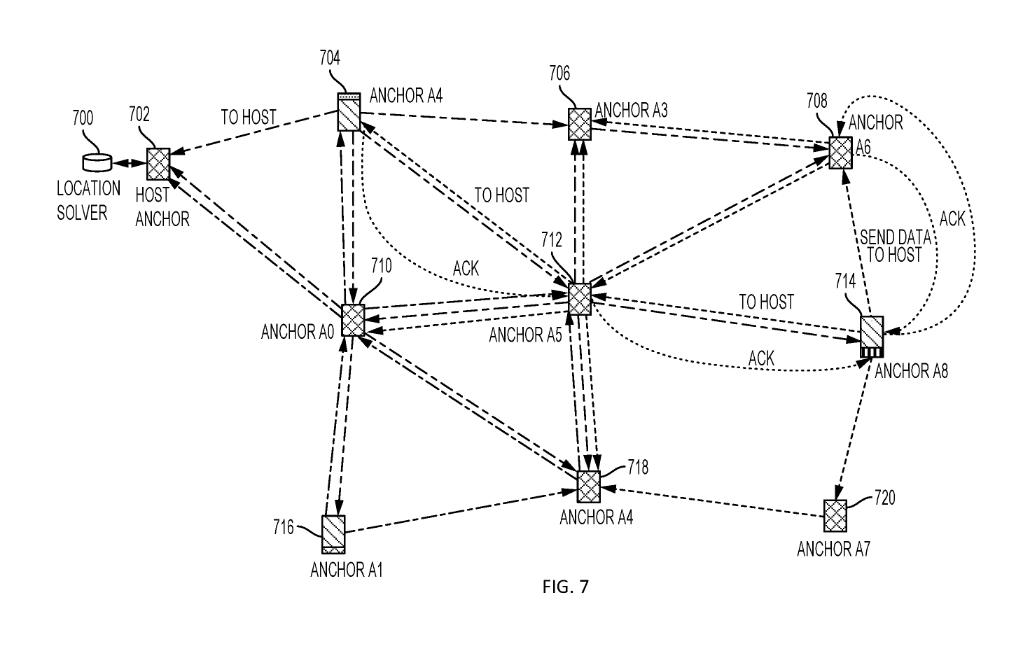

In another example, shown in FIG. 7, the system may be configured with relays/beacons, e.g. forming a mesh. Specifically, select nodes (i.e., select fixtures) are turned into relays/beacons. Each relay/beacon is aware of its neighbors and their neighbors. It essentially knows the best path to forward packets through the matrix based on the location solver's path planning that was previously discussed. The best path through the mesh form by the relays/beacons to the host is calculated by the location solver based on planning that prioritizes the path that leads to another beacon. The acknowledge messages shown between anchors 702-720 are implemented so that in the case of loss of a relay/beacon, the last node that forwards it to the relay/beacon can send it to another relay/beacon neighbor or to another anchor so that it can find another relay/beacon. Advantages of using relays, is that it is easy to recover cases of lost nodes/relays; not every node needs a routing table; relays know the most efficient path to the host; relays can also serve as beacons to allow auto-registration of new tags; and the system can update the most efficient path based on whether the neighboring nodes are alive or not.

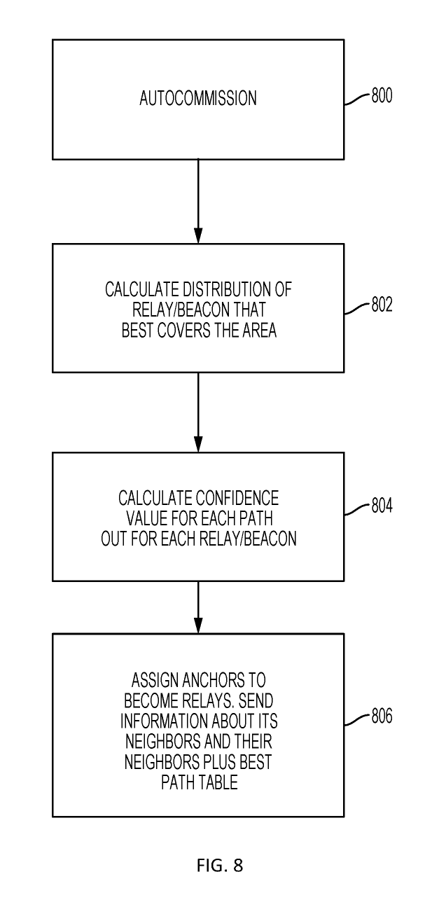

FIG. 8 shows a general flowchart of the relay/beacon process shown in FIG. 7. Specifically, in step 800, auto-commissioning occurs. In step 802, the system calculates a distribution of relays/beacons that best covers the overall area. In step 804, the system calculates a confidence value for each path for each relay/beacon. This is performed by the location solver. Finally, in step 806, the location solver assigns anchors to become relays, and sends information about its neighbors and their neighbors including path tables.

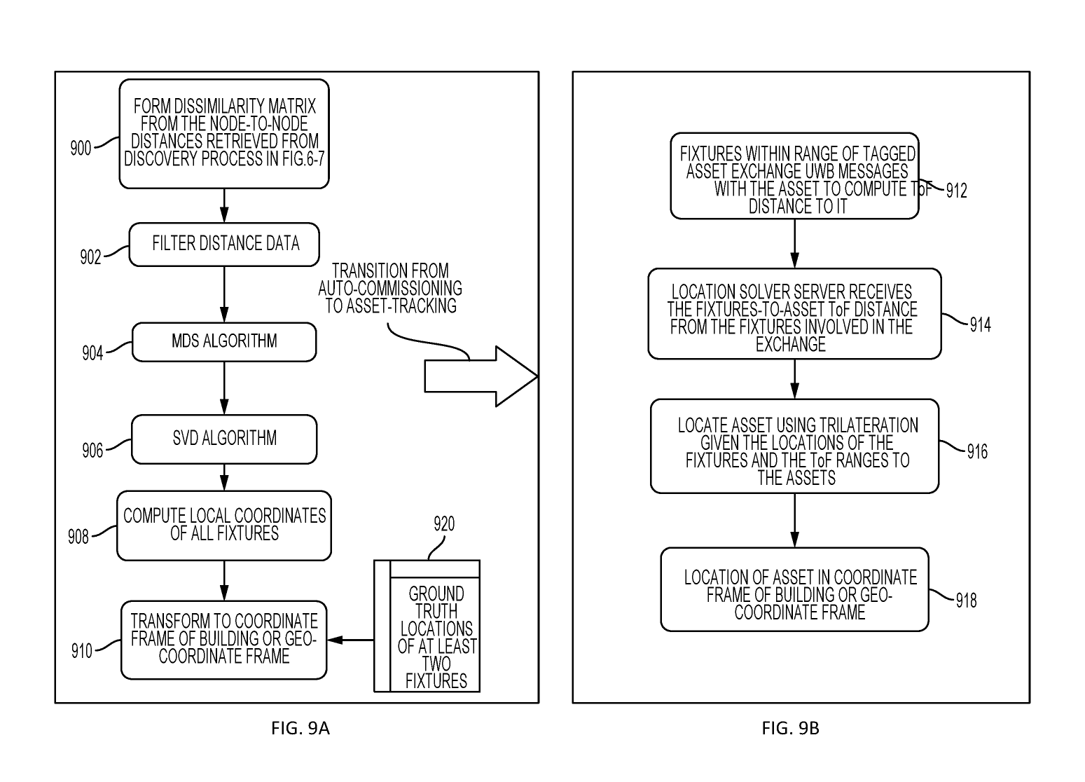

As described with respect to FIGS. 1-8, the overall system first performs an auto-commissioning process and may then perform an asset tracking process. A flowchart in FIGS. 9A and 9B shows the relationship between the auto-commissioning process and the asset tracking process. Specifically, the auto-commissioning process is shown in the flowchart in FIG. 9A, whereas the asset tracking process is shown in the flowchart in FIG. 9B.

For example, during auto-commissioning, once the location solver receives the ToF values from each of the light fixtures, it computes a dissimilarity matrix from node-to-node distances in step 900. These distances are then filtered in step 902. In step 904, the location solver performs multi-dimensional scaling on the filtered distances to obtain the vectors between the nodes. In general, multi-dimensional scaling (MDS) allows a system or user to visualize how far points are to each other given the distances between them. In other words, it allows the system to map the relative positions of the points (objects such as the light fixtures which are the anchors in the example). MDS uses a table of distances between points, which may be referred to as a proximity matrix. The relative coordinates of each fixture in the local coordinate plane are then derived by performing singular value decomposition (SVD) processing on the vectors as shown in step 906.

In step 908, the location solver computes the local coordinates of all the fixtures, and then in step 910 transforms these local coordinates to the actual coordinates of the building in which the fixtures are located. The local coordinate is that with reference to the anchors (in the example, the transceivers embedded in the light fixtures), whereas the geographic coordinate is with respect to the geographic longitude/latitude. The location solver, in conjunction with the anchors, computes the coordinate of the tag location in the local coordinate frame (the orientation of this frame depends on the configuration of the anchors). For system commissioning, it may be appropriate to determine the coordinate of the tag location with respect to the building plan or the like. The building plan is already in the geographic coordinate frame. Step 910 does the transformation of the tag coordinate from the local coordinate frame to the geographic coordinate frame. As described in step 920, the ground truth locations of at least two fixtures are utilized to perform this transformation. Ground truth in the example refers to fixtures or locations that have been geo-located and can be used as reference points by the location solver.

Once the auto-commissioning process is complete, the asset tracking process may begin. As shown in step 912, the fixtures within range of tagged assets (i.e., products on the floor, mobile users, etc.) exchange RF (UWB) messages in order to compute ToF values. The location solver receives these ToF values in step 914 and then performs trilateration in step 916 in order to determine the locations of the assets relative to the fixtures. Finally, in step 918, location of the asset in a 2-dimensional coordinate frame oriented with the actual building is computed similar to the transformation that occurs in step 910.

While the foregoing has described what are considered to be the best mode and/or other examples, it is understood that various modifications may be made therein and that the subject matter disclosed herein may be implemented in various forms and examples, and that the teachings may be applied in numerous applications, only some of which have been described herein. It is intended by the following claims to claim any and all applications, modifications and variations that fall within the true scope of the present teachings.

Unless otherwise stated, all measurements, values, ratings, positions, magnitudes, sizes, and other specifications that are set forth in this specification, including in the claims that follow, are approximate, not exact. They are intended to have a reasonable range that is consistent with the functions to which they relate and with what is customary in the art to which they pertain.

It will be understood that the terms and expressions used herein have the ordinary meaning as is accorded to such terms and expressions with respect to their corresponding respective areas of inquiry and study except where specific meanings have otherwise been set forth herein. Relational terms such as first and second and the like may be used solely to distinguish one entity or action from another without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “a” or “an” does not, without further constraints, preclude the existence of additional identical elements in the process, method, article, or apparatus that comprises the element.

In addition, in the foregoing Detailed Description, it can be seen that various features are grouped together in various examples for the purpose of streamlining the disclosure. This method of disclosure is not to be interpreted as reflecting an intention that the claimed embodiments require more features than are expressly recited in each claim. Rather, as the following claims reflect, the subject matter to be protected lies in less than all features of a single disclosed example. Thus the following claims are hereby incorporated into the Detailed Description, with each claim standing on its own as a separately claimed subject matter.

1. A system, including:
a plurality of luminaires for location at a premises, each luminaire among the plurality of luminaires including a light source, a processor and a radio frequency (RP) transceiver,
wherein the processor of each respective one of the plurality of luminaires is configured to:
control the RF transceiver of the respective luminaire to transmit ranging signals to neighboring luminaires,
receive, through the RF transceiver of the respective luminaire. a response signal transmitted by the RF transceiver of each of the neighboring luminaires, and
for each respective neighboring luminaire, compute a time of flight (ToF) value[s] relative to the respective neighboring luminaire[s] indicating a time delay between transmitting a ranging signal[s] and receiving the response signal[s] from the respective neighboring luminaire; and
a location solving server including a processor and coupled, to communicate with the luminaires,
wherein the processor of the location solving server is configured to:
receive the ToF values from each respective one of the plurality of luminaires,
compute relative distances between the plurality of luminaires based on the ToF values received from each respective one of the plurality of luminaires, and
determine relative location[s] of each of the plurality of luminaires within the premises based on the computed relative distances between the plurality of luminaires.

2. The system of claim 1, wherein:
the RF transceivers are configured as ultra wide band (UWB) transceivers, and
the processor of the location solving server is configured to compute the, relative location[s] of each of the plurality of luminaires based on the relative distances between the plurality of luminaires using trilateration.

3. The system of claim 1, wherein each of the plurality of luminaires transmits ranging signals to the neighboring luminaires and receives response signals from the neighboring luminaires until the ToF values to the neighboring luminaires are computed. the response signals being transmitted in response to ranging signals received from the neighboring luminaires.

4. The system of claim 1, wherein the processor of the location solving server is further configured to compute a shortest communication path to each of the plurality of luminaires from the location solving server.

5. The system of claim 4, wherein the shortest path is computed by either an A* algorithm or a Dijkstra's shortest path algorithm.

6. The system of claim 4. wherein at least one of the plurality of luminaires is further configured as a relay/beacon that uses the shortest communication path computed by the server to forward packets through other of the plurality of luminaires.

7. The system of claim 1, wherein the processor of the location solving server is further configured to compute the relative distances between the plurality of luminaires using a multidimensional scaling (MDS) algorithm and singular value decomposition (SVD) algorithm.

8. The system of claim 1, wherein the relative locations of the plurality of luminaires are transformed into a geographic coordinate frame where each of the plurality of luminaires is physically located.

9. The system of claim 1, wherein the processor of the location solving server is further configured to:
control the RF transceivers of the plurality of luminaires to: transmit ranging signals to assets, receive response signals from the assets, and compute the ToF values indicating a time delay between transmitting the ranging signals to the assets and receiving the response signals from the assets,
compute relative distances between the assets and the plurality of luminaires based on the ToF values for the signals transmitted to the assets and received from the assets, and
compute relative locations of the assets within the premises based on the computed distances between the assets and the plurality of luminaires.

10. The system of claim 9, wherein the processor of the location solving server is further configured to periodically compute the relative locations of the assets to track the assets as the assets move.

11. A method, including:
controlling, by a processor among, a plurality of processors corresponding to each respective one of a plurality of luminaires, RF transceiver[s] of the respective luminaire among the plurality of luminaires to transmit ranging signals to neighboring luminaires;
receiving, by the the processor of the respective luminaire among the plurality of luminaires, a response signal[s] transmitted by the RF transceiver[s] of each of the neighboring luminaires;
for each respective neighboring luminaire, computing, by the processor of the respective luminaire among the plurality of luminaires, a time of flight (ToF) value[s] indicating a time delay between transmitting a ranging signal[s] and receiving the response signal[s] from the respective neighboring luminaire;
receiving, by a processor of a location solving server, the ToF values from each respective one of the plurality of luminaires;
computing, by the processor of the location solving server, relative distances between the plurality of luminaires based on the ToF values received from each respective one of the plurality of and
determining, by the processor of a location solving server, relative location[s] of each of the plurality of luminaires based on the, computed relative distances between the plurality of luminaires.

12. The method of claim 11, further including:
transmitting, by each of the plurality of luminaires, the ranging signals and the response signals as ultra wide band (UWB) signals, and
computing, by the location solving server, the relative location[s] of each of the plurality of luminaires using trilateration.

13. The method of claim 11, further including:
transmitting by each of the plurality of luminaires the ranging, signals and the response signals until the ToF values to the neighboring luminaires are computed, the response signals being transmitted in response to ranging signals received from the neighboring luminaires.

14. The method of claim 11, further including:
computing, by the location solving server, a shortest communication path from each of the plurality of luminaires to the location solving server.

15. The method of claim 14, wherein the shortest communication path from computation includes:
computing the shortest path by either an A* algorithm or a Dijkstra's shortest path algorithm.

16. The method of claim 14, wherein:
at least, one of the plurality of luminaires is configured as a relay/beacon that uses the shortest communication path computed by the server to forward packets through other of the plurality of luminaires.

17. The method of claim 11, further including:
computing, by the location solving server, the relative distances between the plurality of luminaires using a multidimensional scaling (MDS) algorithm and singular value decomposition (SVD).

18. The method of claim 11, further including:
transforming, by the location solving server, the relative locations of the plurality of luminaires into a geographic coordinate frame where each of the plurality of luminaires is physically located.

19. The method of claim 11, further including:
controlling, by the location solving server, the RF transceivers of the plurality of luminaires to: transmit ranging signals to assets, receive response signals from the assets, and compute the ToF values indicating a time delay between transmitting the ranging signals and receiving the response signals,
computing, by the location solving server, relative distances between the assets and the plurality of luminaires based on the ToF values for the signals transmitted to the assets and received from the assets, and
computing, by the location solving server, relative locations of the assets based on the computed distances between the assets and the plurality of luminaires.

20. The method of claim 19, further including:
periodically computing, by the location solving server, the relative locations to track the assets as the assets move.
